(19) United States
(12) Patent Application Publication
(10) Pub. No.: US 2011/0099525 A1
(43) Pub. Date: Apr. 28, 2011

(54) METHOD AND APPARATUS FOR GENERATING A DATA ENRICHED VISUAL COMPONENT

(76) Inventors: Marek Krysiuk, Berlin (DE); Sylvain Grande, Berlin (DE)

(21) Appl. No.: 12/607,798

(22) Filed: Oct. 28, 2009

(51) Int. Cl. G06F 3/048

(52) U.S. Cl. 715/849

(57) ABSTRACT

An approach is provided for generating a visual component. The visual component configured to create a visual object to retrieve and present place data stored in a repository is generated. The visual object is to be embedded within a website for the presentation of the place data. Storage of the visual component is caused, at least in part. Access to the visual component is selectively permitted.

### BACKGROUND

Service providers (e.g., wireless, cellular, etc.) and device manufacturers are continually challenged to deliver value and convenience to consumers by, for example, providing compelling network services. One area of interest has been the development of web sites that may include place information. To develop these websites, the site developer typically creates a database containing place data and a visual controller to present the place data. However, this process is often cumbersome and time consuming. Moreover, maintaining the place data with up to date information may be time consuming and expensive.

### SOME EXAMPLE EMBODIMENTS

According to one embodiment, a method comprises generating a visual component configured to create a visual object to retrieve and present place data stored in a repository. The visual object is to be embedded within a website for the presentation of the place data. The method also comprises causing, at least in part, storage of the visual component. The method further comprises selectively permitting access to the visual component.

According to another embodiment, an apparatus comprising at least one processor, and at least one memory including computer program code, the at least one memory and the computer program code configured to, with the at least one processor, cause, at least in part, the apparatus to generate a visual component configured to create a visual object to retrieve and present place data stored in a repository. The visual object is to be embedded within a website for the presentation of the place data. The apparatus is also caused to cause, at least in part, storage of the visual component. The apparatus is further caused to selectively permitting access to the visual component.

According to another embodiment, a computer-readable storage medium carrying one or more sequences of one or more instructions which, when executed by one or more processors, cause, at least in part, an apparatus to generate a visual component configured to create a visual object to retrieve and present place data stored in a repository. The visual object is to be embedded within a website for the presentation of the place data. The apparatus is also caused to cause, at least in part, storage of the visual component. The apparatus is further caused to selectively permitting access to the visual component.

According to another embodiment, an apparatus comprises means for generating a visual component configured to create a visual object to retrieve and present place data stored in a repository. The visual object is to be embedded within a website for the presentation of the place data. The apparatus also comprises means for causing, at least in part, storage of the visual component. The apparatus further comprises means for selectively permitting access to the visual component.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of generating a visual component to create a visual object for presentation on a website, according to one embodiment;

FIG. 1B is a diagram of the components of a web platform and a content repository platform, according to one embodiment;

FIG. 1C is a diagram depicting the use of a visual object on a website, according to one embodiment;

FIGS. 2 and 3 are flowcharts of processes for utilizing a visual object, according to one embodiment;

FIG. 4 is a flowchart of a process for generating a visual component, according to one embodiment;

FIGS. 5A-5E are diagrams of graphical user interfaces of visual objects utilized in the processes of FIGS. 2-4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for generating a visual component for presentation on a website are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

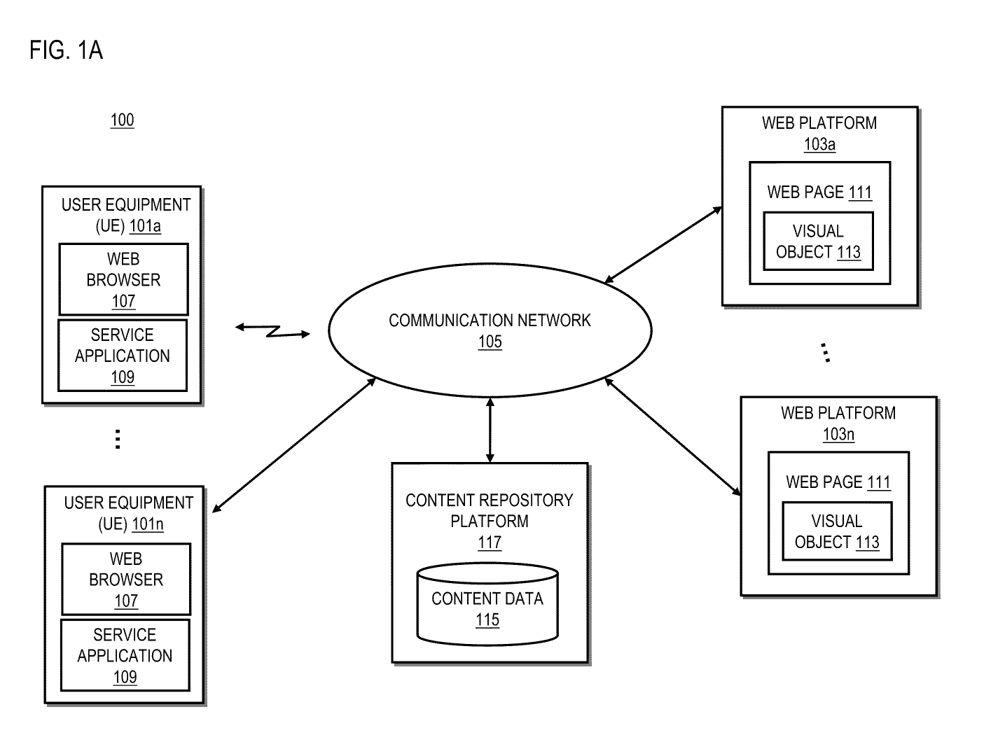

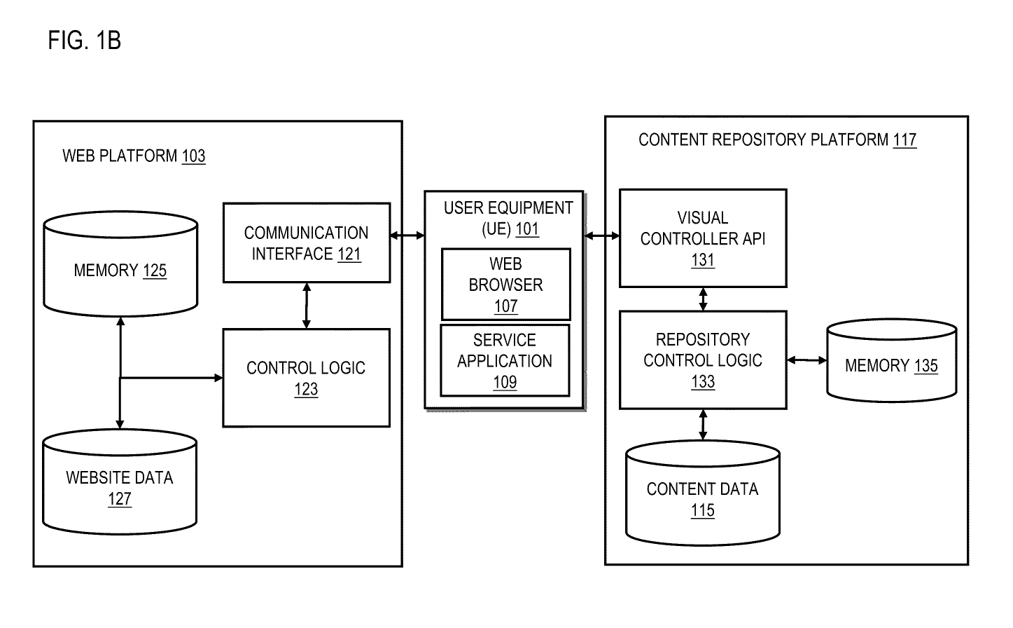

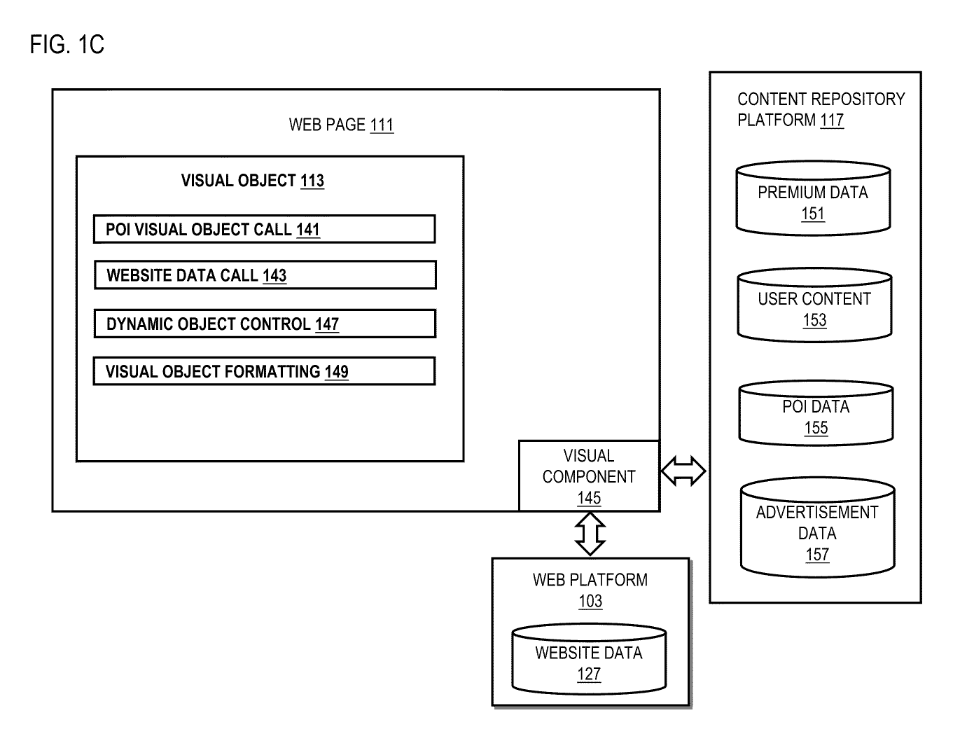

FIG. 1A is a diagram of a system capable of generating a visual component to create a visual object for presentation on a website, according to one embodiment. Currently, many websites cater to the distribution point-of-interest (POI) information (e.g., local searches) when providing location services. According to certain embodiments, a “website” comprises one or more web pages that present content, e.g., text, images, audio content, video content, multimedia content, etc. Each web page can be a document formatted according to a markup language, such as hypertext markup language (HTML), which can employ scripts. One example of such scripting languages include JavaScript™, an object-oriented language for manipulating objects of client-side applications (e.g., web browser) and server-side applications.

As noted earlier, to develop such a website, the developer needs to create a database containing POI data and a visual controller to present the POI data. This can be costly and complex to create due to the vast amount of data associated with creating such a website. Further, local POI data databases may be incompatible with other visual controllers. Moreover, POI data maintenance due to changing POI data may be required for providing current information, which may be costly to a developer. Additionally, many smaller website developers, including individuals, may not have sufficient resources to embark on an endeavor that requires creating and maintaining a POI data database as well as a visual controller.

To address this problem, a system 100 of FIG. 1A introduces the capability to generate a visual component to create a visual object for presentation on a website. In certain embodiments, the visual component may include a software library that may be provided to online service developers to generate one or more visual objects that may be used to present, interact with, and update content. A software library may include components (e.g., objects, functions, data structures, etc.) written in one or more software languages such as JavaScript™, C, Java, Hyper Text Markup Language (HTML), Extensible Markup Language (XML), asynchronous JavaScript™ and XML (AJAX), etc. Further, a visual component may include additional tools to such as the use of JavaScript™ Object Notation (JSON), Cascading Style Sheets (CSS), etc. In certain embodiments, a visual object is a software object that can be embedded in an online service such as a website (e.g., a web page such as a local services website, local information web page, a social networking website, etc.) or email or other message for presentation to one or more users. Certain embodiments may refer to actions dealing with a web page; however it should be recognized that a web page can be used in conjunction with or substituted by various online services. Software objects are self-contained collections of data and methods and used, for example, in object-oriented programming (OOP). By way of example, light-weight applications (e.g., a map application) based on standard web technologies (e.g., web runtime (WRT)—a web application runtime environment included in many browsers), that serve as frontends or clients to web-based or other content may be used to present a visual object. Visual objects provide a convenient means for presenting information and accessing services from one or more web service providers. It is also contemplated that approach to generating and sharing visual components can be extended to applications, other than websites.

By way of example, user equipment (UEs) 101a-101n may utilize one or more web platforms 103a-103n via a communication network 105. A UE 101 may use a web browser 107 or a service application 109 to access a web page 111 with an embedded visual object 113. The visual object 113 is then utilized on the web browser 107 or service application 109. Under one scenario, the web browser 107 may load the web page 111 and visual object 113. In this scenario, the web page 111 and visual object 113 may be related to a local information service. The visual object 113 may be configured to call functions (e.g., via JavaScript™) to retrieve repository content data 115 (e.g., POI data) from a content repository platform 117. As noted above, a visual component may be used to generate the visual object 113. The visual component may include a software library or portions of a software library that includes objects and/or functions to present, use, augment, create, update the repository content data 115, or the like on the content repository platform 117.

FIG. 1B is a diagram of the components of a web platform 103 and a content repository platform 117, according to one embodiment. When a user of the UE 101 requests a web page 111 from the web platform 103, the communication interface 121 of the web platform 103 receives the request and forwards the request to control logic 123. The control logic 123 then retrieves web page information from a memory 125 (e.g., a volatile memory or a non-volatile memory). The web page information may include website data 127 that includes content associated with the web page 111. The web page information may include code specifying the visual object 113. The web page 111 and the visual object 113 may then be transmitted to the UE 101 for presentation on the web browser 107 or service application 109.

The UE 101 then receives information about the web page 111 as well as the visual object 113. The UE 101 may further includes information associated with a visual component (e.g., a software library) utilized to generate the visual object 113. The visual component may provide the visual object 113 tools (e.g., software libraries) used to access (e.g., via routines) visual information of content data 115 from a content repository platform 117 or website data 127 from the web platform 103 as further described in FIG. 1C. A communication interface of the UE 101 may be utilized to send/receive information to/from the content repository platform 117 and/or the web platform 103.

The content repository platform 117 may receive/send information from/to the UE 101 using a communication interface and a visual controller application programming interface (API) 131. The visual controller API 131 may interpret and process requests (e.g., via routines, functions, etc.) from the visual object 113. The visual controller API 131 may be used to interface with the visual object 113 via functions that may be included in the visual component. The visual controller API 131 may include a data provisioning service. The visual controller API may receive descriptions of the data the visual object wishes to present via communications from the visual object 113 using the visual component. The visual controller API 131 may then use repository control logic 133 to determine which content data 115 to fetch. The repository control logic 133 may store this information in memory 135 and format the data into a visual form. This visual form may be returned to the UE 101.

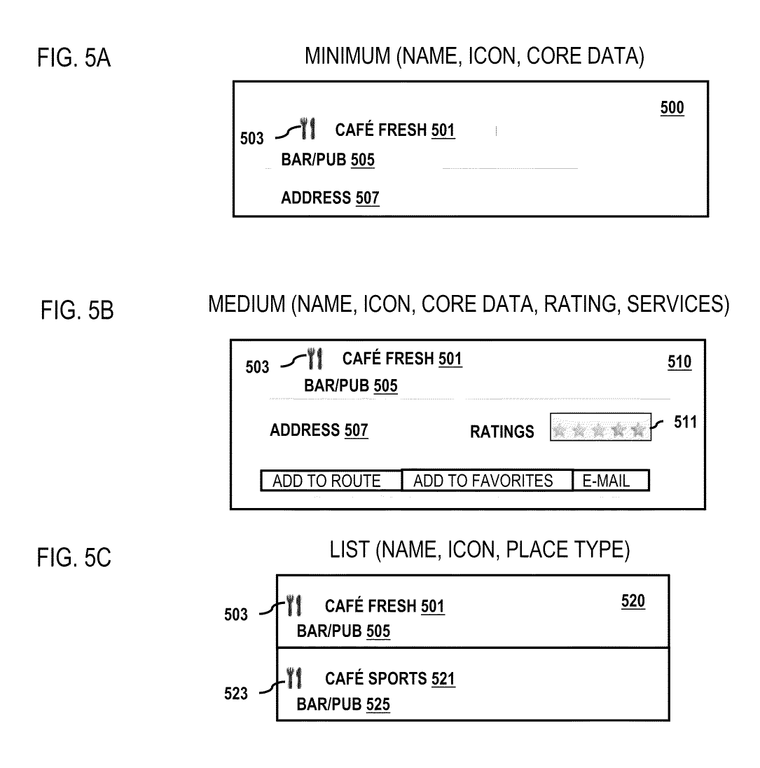

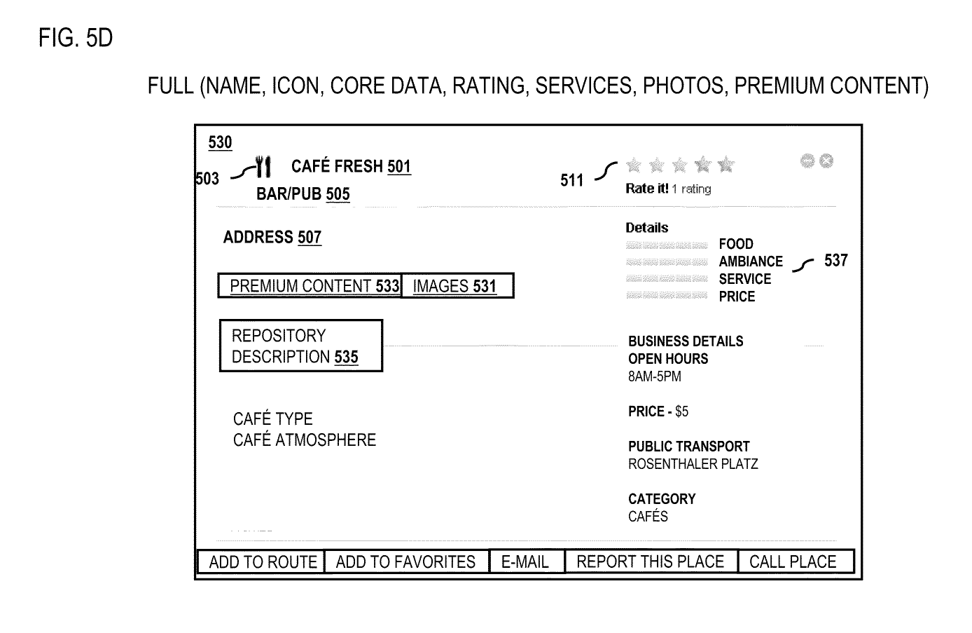

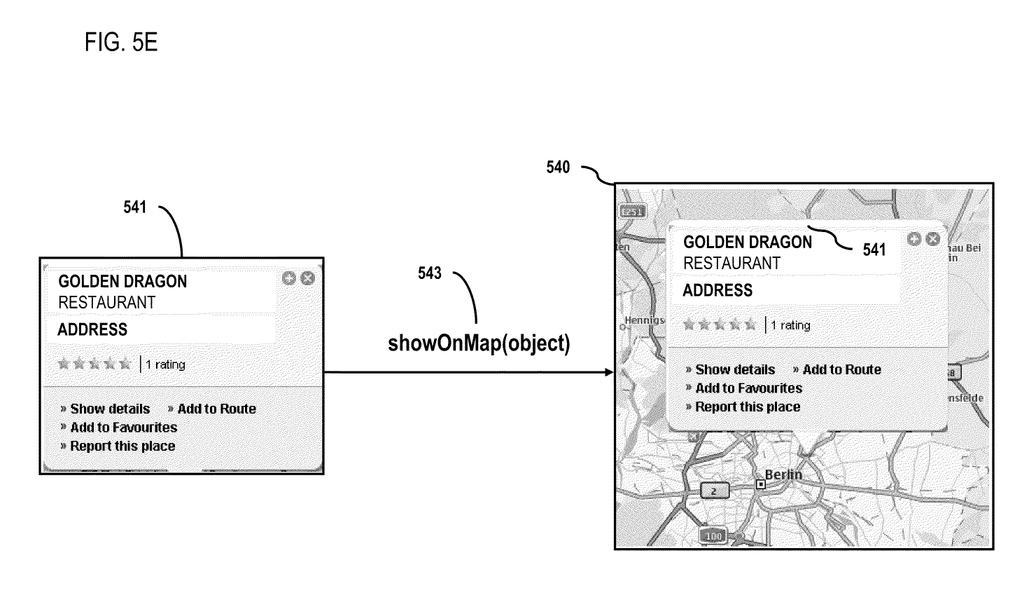

In one exemplary embodiment, the UE 101 uses the web browser 107 to browse a web page 111 regarding local information about a POI with a visual object 113 representing the POI. Information about the POI may be available on the web page 111. The web browser 107 may utilize the visual component to request that the POI be visualized on a web portal (e.g., the visual object 113) of the web page 111. The information about the POI may include an identifier that may be used to select the POI. The identifier may be associated with a place set available to a developer of the web page 111 and the UE 101 via the visual component. Descriptors of the POI may include a unique name of the POI, a rating of the POI, a location of the POI, other customizable information associated with the POI, or a combination thereof. For example, the web page 111 may include a place to hold the visual object 113 and specify that the visual object 113 is for POI “uniquePOI.” The web page 111 may also include information about a style to format the visual object 113 with. Styling options may also be included in the visual component. Further examples of styling options are described in the descriptions of FIGS. 5A-5E. The call for a visual object 113 for a uniquePOI is transmitted to the visual controller API 131 of the content repository platform 117. The visual controller API 131 retrieves content about the POI from the content data 115 and formats it into a visual form that is transmitted to the UE 101. The UE 101 then presents the visual object 113 to the user of the UE 101 (e.g., via a user interface).

As shown in FIG. 1A, the system 100 comprises a user equipment (UE) 101 having connectivity to the content repository platform 117 and web platform 103 via the communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, navigation device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, content repository platform 117, and web platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the visual object 113 and the content repository platform 117 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 1C is a diagram depicting the use of a visual object 113 on a website, according to one embodiment. The visual object 113 may include functions that can be used to generate the visual object 113, such as a POI visual object call 141. The POI visual object call 141 may be used in conjunction with a POI identifier (e.g., uniquePOI) to retrieve the visual object 113 from the content repository platform 117. Moreover, a portion of the visual object 113 may be saved for including website data 127 associated with the web platform 103. A website data call 143 may be provided by the visual component 145. In this manner, the website developer is able to include additional value added information to the visual object 113. The visual object 113 may be configured to retrieve data from a database associated with the website and present the data. Moreover, the visual component 145 may include functions and objects to include dynamic object control 147 in the visual object 113. Dynamic object control 147 may include functions to allow a user to determine the POI the object is associated with, information the user would like to view about the POI, etc. The information in the visual object 113 may be controlled using visual object formatting 149. The visual object formatting 149 may be implemented using functions of the visual component 145 or using style sheets (e.g., CSS) that may also be associated with the visual component 145.

In one example, the dynamic object control 147 may allow the user to interactively utilize features of the content repository platform 117, such as premium features available from the content repository platform 117 via premium data 151. Premium data 151 may include information that may only be retrieved if the user is subscribed or registered to receive the content. Premium features may include premium content (e.g., video, audio, photographs, coupons, direct phone numbers, etc.) associated with the POI. The user may interactively authenticate using the visual object 113. The authentication procedures may be included in the visual component 145. Alternatively or additionally, the authentication procedures (e.g., exchange of credentials) may be provided by the hosting web page 111. Once logged into the web page 111, the visual component 145 may interact with the web page 111 to retrieve authentication information (e.g., user name and password, web page authentication key, etc.) that may further be used to authenticate with the content repository platform 117. Thus, the user need only authenticate once with the web page 111 to authenticate and utilize the content repository platform 117. Moreover, the user is able to utilize user content 153 from the content repository platform 117. The user content 153 may include information such as ratings, user reviews, etc. The user may, via the visual object and dynamic object control 147 add to the user content 153 via the visual controller API 131 of the content repository platform 117. For example, the user may rate a place from a web page 111, where the visual object and visual component 145 are embedded, and transmit the rating, via the visual component to the content repository platform 117 to update the user content 153. Moreover, as stated above, POI data 155 may be provided to the user via the UE 101. Further, the user may create a POI from the web page 111 and update the POI data 155 via the visual component 145 as further detailed in FIG. 4. Further, the visual controller API 131 may include advertisement data 157 (e.g., commercials, coupons, banners, etc.) in the visual object 113. When accessing the content repository content data 115, the visual object 113 requests visual information from the visual controller API 131, which retrieves the content from the content data 115 and formulates the content into a visual data elements. The visual object 113 may include one or more visual data elements provided by the visual controller API 131 and which may be formatted using the visual object formatting 149. Further, as noted above, the visual object 113 may be configured to receive input that may be utilized to modify the format and presentation of the visual data elements.

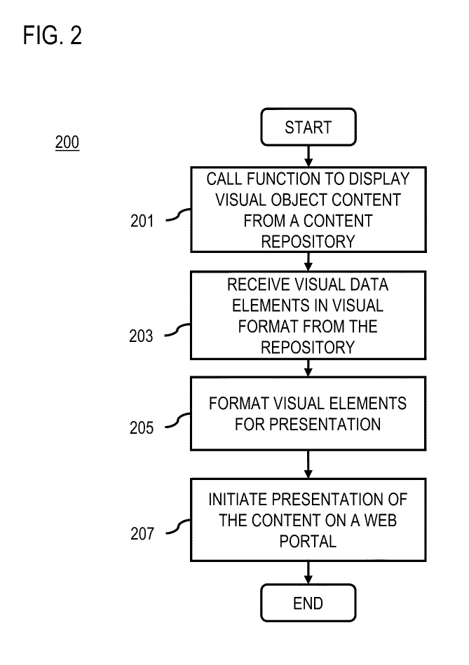

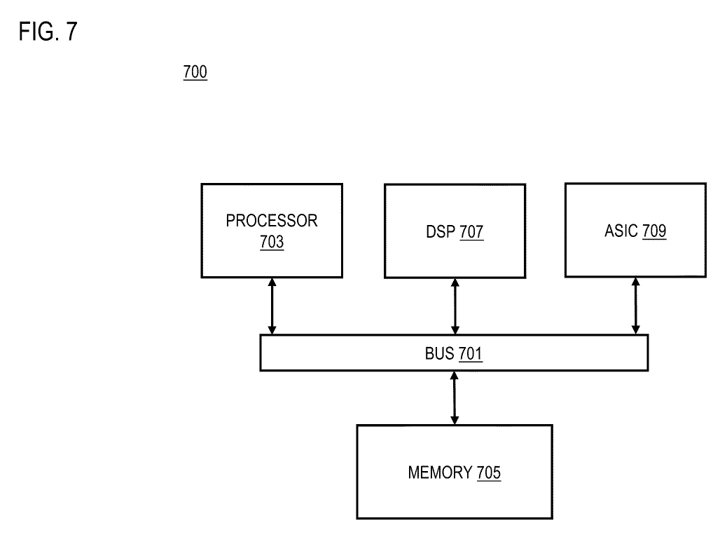

FIG. 2 is a flowchart of a process for utilizing a visual object 113, according to one embodiment. In one embodiment, control logic on the UE 101 performs the process 200 and is implemented in, for instance, a chip set including a processor and a memory as shown FIG. 7. The user of the UE 101 may navigate to a web page 111 that includes embedded in the web page 111 a visual object 113 associated with a visual component 145. The control logic retrieves and interprets the web page 111. Next, the control logic then calls a function to display content associated with the visual object 113 from a content repository platform 117 (step 201). The web page 111 may have, embedded within the web page 111, information specifying the content. The visual component 145 may include information to associate the content repository platform 117 with the specified content.

Then, the UE 101 receives visual data elements in visual format from the content repository platform 117 (step 203). In certain embodiments, the visual data elements may be in the form of a complete visual object 113. These visual data elements can include representations of content as further described in the user interfaces in FIGS. 5A-5E. The visual data elements may be formatted using functions or style sheets made available by the visual component 145 (step 205). In certain embodiments, formatting is not necessary at this stage because the visual data element in the form of the visual object 113 is received from the content repository platform 117. Then, the visual object 113 may be presented to the user via a web portal (step 207). The user may then interact with the visual object 113 to use, generate, or view additional content.

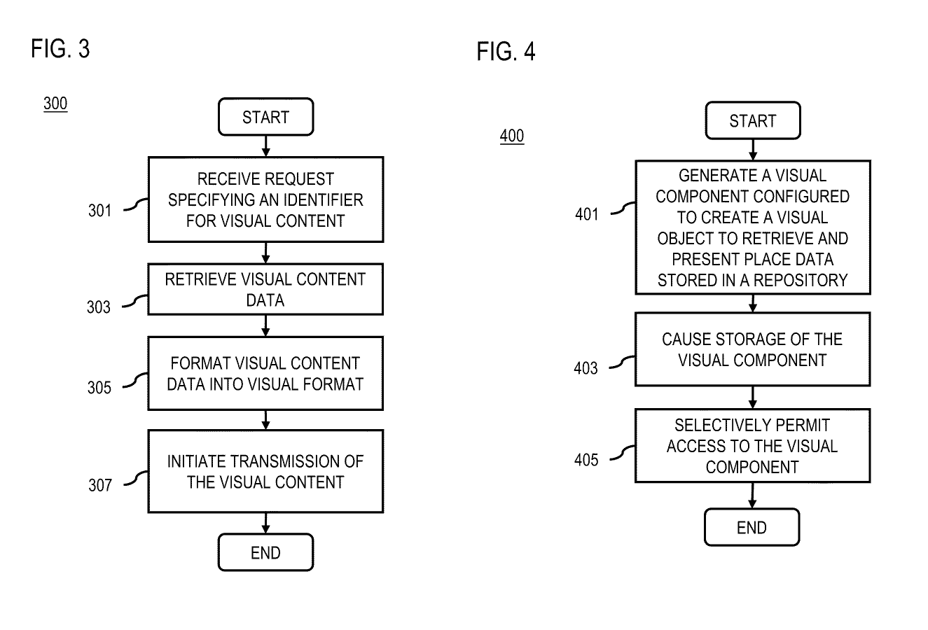

FIG. 3 is a flowchart of a process for utilizing a visual object, according to one embodiment. In one embodiment, the visual controller API 131 performs the process 300 and is implemented in, for instance, a chip set including a processor and a memory as shown FIG. 7. In step 301, the visual controller API 131 of a content repository platform 117 receives a request specifying an identifier for visual content from a UE 101. The request can be made using functions associated with a visual component 145. Moreover, the visual content may be associated with a POI and can include information about the POI. The visual content is then retrieved from content data 115 stored in one or more databases associated with the content repository platform 117 (step 303). The content visual controller API 131 may retrieve the content by associating the identifier with a list of identifiers and determining the location (e.g., an address) of the content in a database. Then, the content may be formatted from data form into a visual format that can be displayed by the UE 101 (step 305). The visual format may include one or more visual data elements such as an image associated with a text box, an icon, another image, a video, etc. The visual format may also include interactive or dynamically changing components (e.g., an input text box, ratings, input from other locations, etc.). Moreover, the visual object 113 may format data (e.g., a visual data element or other content formatted in a manner prescribed by an object or function of the visual component 145) received from a website for presentation using a function associated with the visual component 145. In certain embodiments, the visual controller API 131 further receives formatting parameters from the UE 101 that indicates the manner in which the visual data elements should be organized. In these embodiments, the visual format, which may be transmitted, may be a complete visual object 113. In other embodiments, the content is not visually formatted at the visual controller API 131 and is later formatted at the UE 101 (e.g., by performing the processes of step 305) using the visual component 145. Then, at step 307, the visual controller API 131 initiates transmission of the visual content (in formatted or unformatted form) to the UE 101. The visual content may include a visual object 113, visual data elements, or other information that may be used to describe the visual content.

FIG. 4 is a flowchart of a process for generating a visual component, according to one embodiment. In one embodiment, the control logic 123 or repository control logic 133 performs the process 400 and is implemented in, for instance, a chip set including a processor and a memory as shown FIG. 7. In step 401, a visual component 145 configured to create a visual object 113 to retrieve and present place data stored in a content repository platform 117 is generated. As described above, the visual component 145 may be implemented as a software library (e.g., a JavaScript™ library). The software library may include objects, functions, etc. to communicate with a visual controller API 131 to receive visual content (e.g., a presentation of place data). Moreover, the visual component 145 may be provided to a website developer to develop website content. For example, the website developer may include content on the website from the content repository platform 117 by using the visual component 145. The content can include use of the visual object 113. The visual component 145 (or a portion of the visual component 145, which may also be considered a visual component 145) may be caused to be stored in a database. The visual object 113 may be embedded within a website for the presentation of the visual data (e.g., place data).

In certain embodiments, the visual component 145 includes one or more functions to call a place set from the content repository platform 117 that may be used to map unique identifiers POI information in a POI data database. The content repository platform 117 may additionally provide a service to users to allow the user or developer to retrieve the identifiers based on searches (e.g., a search function of the visual component 145). Further, the content repository platform 117 may provide users access to add information to the POI data 155 or to the place set using the visual component 145. These services may require authentication (e.g., via a premium account or registration). Once created, the place and POI information may be used by other users and website developers. During the creation process, the place and POI information may be compared to existing places to avoid duplicate entries for the same place. Moreover, a local place set for specific websites may be created that are a subset of the place set available from the content repository platform 117. In this manner, website developers may predetermine and select sets of places that the website developer wishes to allow to be viewed on the developer's website.

In certain embodiments, the visual component 145 includes one or more parameters or functions to include advertisements within the visual object 113. The visual object 113 may optionally place the advertisement data 157 on its own initiative (without developer instructions) if the visual object 113 has available space. In certain embodiments, the visual component 145 provided to developers and users may be limited to functions that call advertisement data 157 within one or more visual objects or have one or more functions that may require the display of advertisement data 157. Thus, a visual data element of advertisement data 157 may be included in the visual object 113.

Further, the website developer may wish to cause storage of the visual component 145 in the website (e.g., via embedding the visual component into the web page 111, via a web plugin, etc.) (step 403). By storing the visual component 145 as part of the website, the website developer or provider of the content repository platform 117 may selectively permit access to the visual component 145 (step 405). In certain embodiments, the content repository platform 117 may provide access to the source code of the visual component 145 to the website developer for a cost. In other embodiments, the visual component 145 (e.g., in a source form or a compiled form) may be provided to the UE 101 for using the content repository platform 117. Generated instances of the visual component 145 on the UE 101 may be used to utilize features (e.g., functions, objects, etc.) of the visual component 145.

In one example, a website developer may be tasked to create a website for a client in the hotel business; as such, the website may include an embedded list of recommended restaurants in the area. It may be important for the website developer to include information about the restaurants, including visual information, however, the developer may not want to incur the expense and effort in creating a database for storing information about restaurants as well as the associated visual controller for presenting the restaurant information. Instead, the developer may utilize the content repository platform 117 to embed the information via the visual component 145.

In another example, a website developer is a user of a social network. In this embodiment, the user may want to utilize a compiled plugin version of the visual component 145 to include in the user's web page. The user may be able to select one or more places that the user would like to display (e.g., updating places that the user has been). Additionally or alternatively, the user may wish to embed the visual component 145 within an instant messaging tool. The instant messaging tool may be used to determine a location based on the internet protocol address or other location information (e.g., using a global positioning system) associated with the user and display content of nearby locations based on the location information.

The above approach allows for developers and users to conveniently utilize the services of a content repository platform 117 by simply calling functions from a visual component 145. In this manner, the visual component 145 allows the website developer to use an identifier obtain visual content from the content repository platform 117. Also, via the compatibility of using the visual component 145, multiple website developers may utilize the content repository platform 117. This furthers the efficiencies of the website developers from needing to create and manage a local data store that may be replaced by the content repository platform 117.

FIGS. 5A-5E are diagrams of graphical user interfaces of visual objects utilized in the processes of FIGS. 2-4, according to various embodiments. FIG. 5A displays a visual display of a visual object formatted with a minimum information 500 of display content about a place (e.g., Café Fresh) using a visual component 145. The visual component 145 may include a set of default placements of the content based on a parameter that may be used to retrieve the data (e.g., a format parameter or a type of function call). For example, different functions associated with the visual component 145 may be used to call standard placement settings of minimum information 500, medium information 510, a list of information 520, or a full information 530. The minimum information 500 may include a name 501, icon 503, and core data, such as a type of place 505 and address 507. The medium information 510 may additionally include ratings 511 as well as services (e.g., via interactive service buttons) such as adding a place to a navigational route, adding the place to favorite places, e-mailing the place, calling the place, etc. Additionally, the list information may include portions of information (e.g., name 501, icon 503, and place type 505) while excluding other features. Moreover, a list visual object may include information about more than one place. Thus, a function calling a list may specify multiple places (e.g., a including Café Fresh and Café Sports). Consequently, both may be displayed in one visual object. The object can be produced by the content repository platform 117.

FIG. 5D is a diagram of an exemplary visual object displaying full information 530 of a place (e.g., Café Fresh). This view may additionally include images 531 of the place or premium content 533. Moreover, the view may include a description 535 associated with the repository as well as business details, price information, and public transportation that may be used to arrive at the place. Additionally, the user is able to interact with certain information, such as the general ratings 511 and detail ratings 537. In this manner, the user is able to add to a user content database associated with the place. Moreover, the user may utilize tabs or links within the visual object to retrieve and interact with other dynamic data elements (e.g. images 531) that may be displayed within the visual object (e.g., in place of the repository description 535). Alternatively or additionally, a website developer developing a web page may customize a visual object (e.g., a visual object displaying full information 530) using functions and style sheets that may be associated with the visual component 145. For example, individual visual data elements (e.g., name 501, icon 503, rating 511, etc.) may be hidden or modified (e.g., presenting a numerical score for ratings instead of stars. Moreover, website developer content may be added using these customizations or using a predetermined place container (e.g., visual object) with a visual data element reserved for developer content.

FIG. 5E is a diagram of an exemplary graphical user interface 540 displaying a visual object 541 being displayed on a map. The website developer may embed on a map web page a function calling the visual object 541 to be displayed on the map. The visual object 541 may be customized to display content useful for a map display. Further, the visual object 541 may include callback functions that can be used to dynamically update and rescale the visual object based on changes to the map (e.g., zooming in or out, panning, etc.).

The processes described herein for generating a visual component for presentation on a website may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

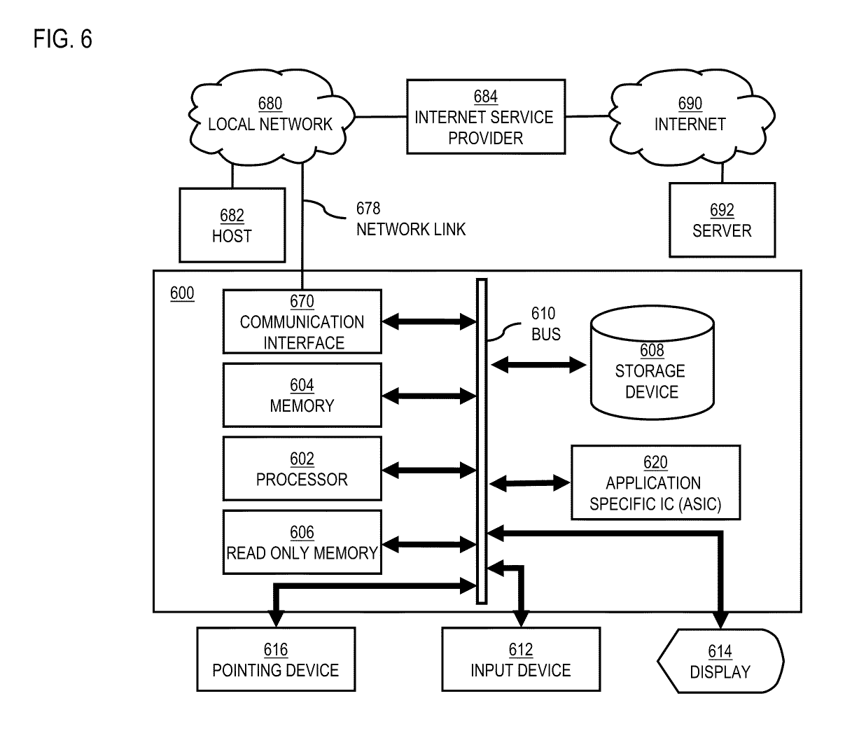

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to for generate a visual component for presentation on a website as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of for generating a visual component for presentation on a website.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to for generating a visual component for presentation on a website. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for generating a visual component for presentation on a website. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for generating a visual component for presentation on a website, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to for generate a visual component for presentation on a website as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of for generating a visual component for presentation on a website.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to for generate a visual component for presentation on a website. The memory 705 also stores the data associated with or generated by the execution of the inventive steps.

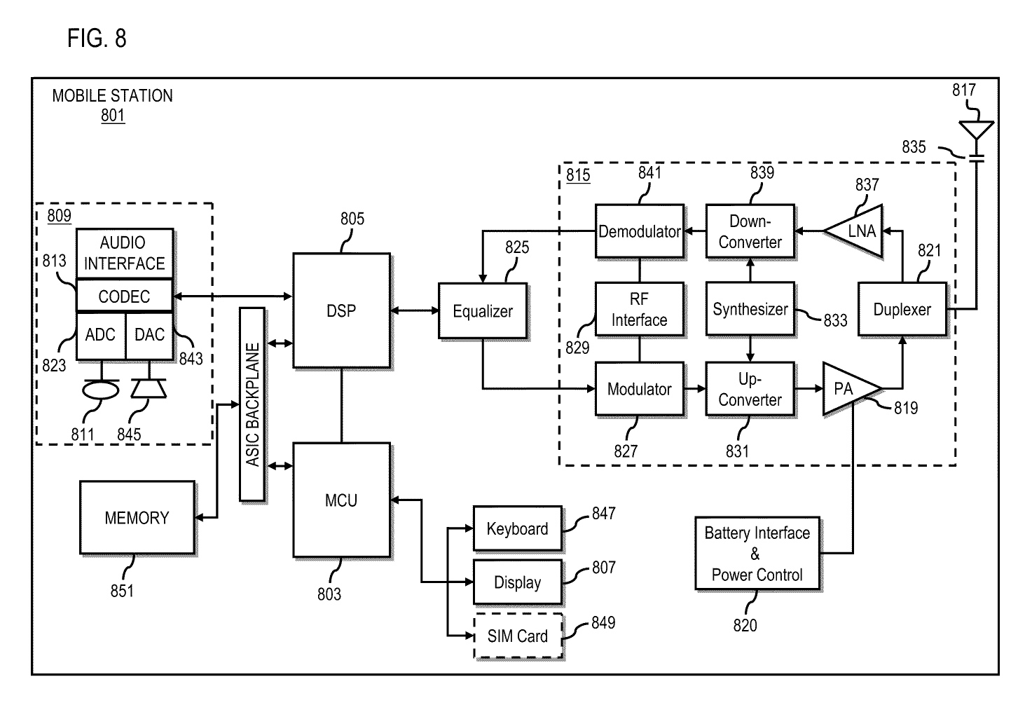

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of for generating a visual component for presentation on a website. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of for generating a visual component for presentation on a website. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to for generating a visual component for presentation on a website. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
generating a visual component configured to create a visual object to retrieve and present place data stored in a repository, wherein the visual object is to be embedded within a website for the presentation of the place data;
causing, at least in part, storage of the visual component; and
selectively permitting access to the visual component.

2. A method of claim 1, wherein the visual object is configured to retrieve the place data in a visual format from the repository.

3. A method of claim 1, wherein the visual object is configured to retrieve visual elements associated with the place data and to format the visual elements for the presentation.

4. A method of claim 3, wherein the visual object is further configured to format the visual elements based on one or more functions provided by the visual component.

5. A method of claim 3, wherein at least one of the visual elements represents advertisement data and the visual component requires the presentation of the advertisement data.

6. A method of claim 3, wherein the visual object is further configured to retrieve data from a database associated with the website and format the data for presentation with the visual elements.

7. A method of claim 3, wherein the visual object is further configured to receive input and modify the use of visual elements based on the input.

8. An apparatus comprising:
at least one processor; and
at least one memory including computer program code,
the at least one memory and the computer program code configured to, with the at least one processor, cause, at least in part, the apparatus to perform at least the following,
generate a visual component configured to create a visual object to retrieve and present place data stored in a repository, wherein the visual object is to be embedded within a website for the presentation of the place data;
initiate storage of the visual component; and
selectively permit access to the visual component.

9. An apparatus of claim 8, wherein the visual object is configured to retrieve the place data in a visual format from the repository.

10. An apparatus of claim 8, wherein the visual object is configured to retrieve visual elements associated with the place data and to format the visual elements for the presentation.

11. An apparatus of claim 10, wherein the visual object is further configured to format the visual elements based on one or more functions provided by the visual component.

12. An apparatus of claim 10, wherein at least one of the visual elements represents advertisement data and the visual component requires the presentation of the advertisement data.

13. An apparatus of claim 12, wherein the visual object is further configured to retrieve data from a database associated with the website and format the data for presentation with the visual elements.

14. A method of claim 10, wherein the visual object is further configured to receive input and modify the use of visual elements based on the input.

15. A computer-readable storage medium carrying one or more sequences of one or more instructions which, when executed by one or more processors, cause an apparatus to at least perform the following steps:
generating a visual component configured to create a visual object to retrieve and present place data stored in a repository, wherein the visual object is to be embedded within a website for the presentation of the place data;
causing, at least in part, storage of the visual component; and
selectively permitting access to the visual component.

16. A computer-readable storage medium of claim 15, wherein the visual object is configured to retrieve the place data in a visual format from the repository.

17. A computer-readable storage medium of claim 15, wherein the visual object is configured to retrieve visual elements associated with the place data and to format the visual elements for the presentation.

18. A computer-readable storage medium of claim 17, wherein the visual object is further configured to format the visual elements based on one or more functions provided by the visual component.

19. A computer-readable storage medium of claim 17, wherein the visual object is further configured to retrieve data from a database associated with the website and format the data for presentation with the visual elements.

20. A computer-readable storage medium of claim 17, wherein the visual object is further configured to receive input and modify the use of visual elements based on the input.
